(19) United States
(12) Patent Application Publication
(10) Pub. No.: US 2012/0272660 A1
(43) Pub. Date: Nov. 1, 2012

(54) METHOD AND ASSEMBLY FOR RETROFITTING A GAS TURBINE COMBUSTOR END COVER

(75) Inventor: Christopher Garrett, Coventry, CT (US)

(73) Assignee: PROENERGY SERVICES, LLC, Sedalia, MO (US)

(21) Appl. No.: 13/097,536

(22) Filed: Apr. 29, 2011

(51) Int. Cl. F02C 7/20; B23P 17/00

(52) U.S. Cl. 60/796; 29/888

(57) ABSTRACT

A method for retrofitting an end cover of a turbine engine combustor. The method includes inserting a first insert into a opening formed in the end cover so a circular land on the insert centers the insert in the opening and an annular face on the insert engages a face of the opening. The first insert includes a cylindrical tip section opposite the base having a diameter smaller than a diameter of the opening. The base of the first insert is joined to the opening. The method includes inserting a second insert into the opening so an outer diameter of the second insert is positioned inside the diameter of the opening. The second insert has an inner land adapted to engage the outer diameter of the first insert to position the second insert relative to the first insert and the opening. The second insert is joined to the end cover.

### FIELD OF THE INVENTION

The present invention generally relates to gas turbine engines, and more particularly to retrofitting a fuel nozzle assembly of a gas turbine engine combustor end cover.

### BACKGROUND

Frequently, gas turbine engines used to generate power are fueled by low calorific value fuels. Because these fuels are difficult to ignite, secondary fuels such as natural gas or distillate are used during startup. Moreover, operators prefer to have flexibility in the type of fuel they use to take advantage of relative fluctuations in fuel prices. Different fuel-to-air ratios and nozzle configurations are needed to run gas turbine engines using different fuels. To provide for these variations, conventional combustor end covers E such as shown in FIG. 1 have multiple fuel and air passages P leading to each fuel nozzle and swirler cup assembly, generally designated by F. These passages P are formed between the end cover E and inserts I attached to the end cover. Each insert I has several surfaces S that are brazed to the end cover E to hold the insert in place. Multiple braze surfaces S are required to seal different internal passages P from one another.

The nozzle and fuel cup assemblies F are prone to cracking during operation due to high thermal stresses and fatigue. The multi-surface braze joints holding each insert I in place limit the number of repair cycles the end covers E can endure. When the inserts I are removed for replacement, residual braze must be machined from the end cover surfaces corresponding to the insert braze surfaces S to prepare the end cover for receiving new inserts. During machining, base metal is also removed from the surfaces of the end cover openings to ensure all braze material is removed. After a few repairs, the inner diameters of the end cover openings are enlarged beyond acceptable limits for brazing new inserts in the opening. Thus, there is need for a method and assembly to retrofit an end cover E of a combustor of a gas turbine engine having openings machined beyond acceptable limits. Further, there is a need for a method and assembly that tolerate more repairs than conventional methods and assemblies.

### SUMMARY

The present invention relates to a method for retrofitting an end cover of a combustor of a gas turbine engine. The method includes inserting a first insert into a opening formed in an end cover of a combustor of a gas turbine engine so a circular land on the first insert centers the first insert in the opening and so an annular face on the first insert engages a face of the opening. The first insert includes a cylindrical tip section opposite the base having a predetermined outer diameter sized smaller than a diameter of the opening. The base of the first insert is joined to the opening when the base engages the face of the opening to hold the base in position in the opening so the circular land engages the opening. The method further includes inserting a second insert into the opening formed in the end cover so an outer diameter of the second insert is positioned inside the diameter of the opening. The second insert has an inner land adapted to engage the outer diameter of the first insert to position the second insert relative to the first insert and the opening in the end cover. The second insert is joined to the end cover.

In another aspect, the present invention relates to an assembly for retrofitting an end cover of a combustor of a gas turbine engine. The end cover has a opening in it. The assembly comprises a first insert having a circular land sized for centering the first insert in the opening and an annular face adapted to engage a face of the opening when the first insert in inserted in the opening. The first insert also includes a cylindrical tip section opposite the base having a predetermined outer diameter sized smaller than a diameter of the opening and a central opening sized for receiving a fuel nozzle. Further, the assembly comprises a second insert having an outer diameter sized for receipt inside the diameter of the opening, an inner land adapted to engage the outer diameter of the first insert to center the second insert relative to the first insert, and a central opening sized for receiving a swirl cup.

In yet another aspect, the present invention relates to an end cover assembly of a combustor of a gas turbine engine. The end cover assembly includes a plate having a combustion chamber face adapted for facing when in use a combustion chamber and an exterior face opposite the combustion chamber face. The combustion chamber face has a plurality of openings. Each of the plurality of openings includes an annular face face, a circular rabbet land, a diameter, and an opening extending from the opening to the exterior face of the plate. The assembly also includes a plurality of first inserts. Each of the first inserts is positioned in one of the plurality of openings in the plate. Each first insert also has a circular land engaging the circular rabbet land of the corresponding opening for centering the first insert in the opening and an annular face engaging the annular face of the corresponding opening. The first inserts each include a cylindrical tip section opposite the base having an outer diameter smaller than the diameter of the opening and a central opening. In addition, the assembly includes a plurality of second inserts. Each of the second inserts has an outer diameter sized for receipt inside the corresponding opening, a generally circular inner wall interrupted by a plurality of lobes engaging the outer diameter of the first insert to center the second insert relative to the first insert and a central opening.

### BRIEF DESCRIPTION OF THE DRAWINGS

FIG. 1 is a cross section of a combustor end cover having a portion of a conventional fuel nozzle assembly brazed in position;

FIG. 2 is a cross section of a modified end cover having a fuel nozzle assembly of the present invention welded in position;

FIG. 3 is a perspective of a first insert for modifying the end cover; and

FIG. 4 is a perspective of a second insert for modifying the end cover.

Corresponding reference characters indicate corresponding parts throughout the drawings.

### DETAILED DESCRIPTION OF THE DRAWINGS

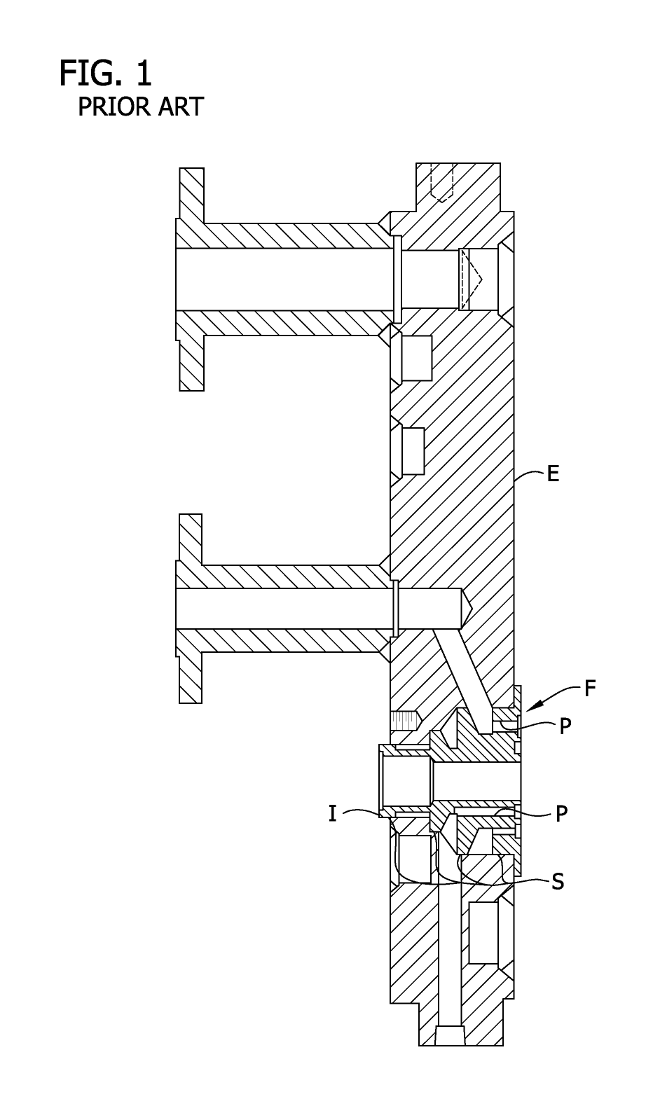

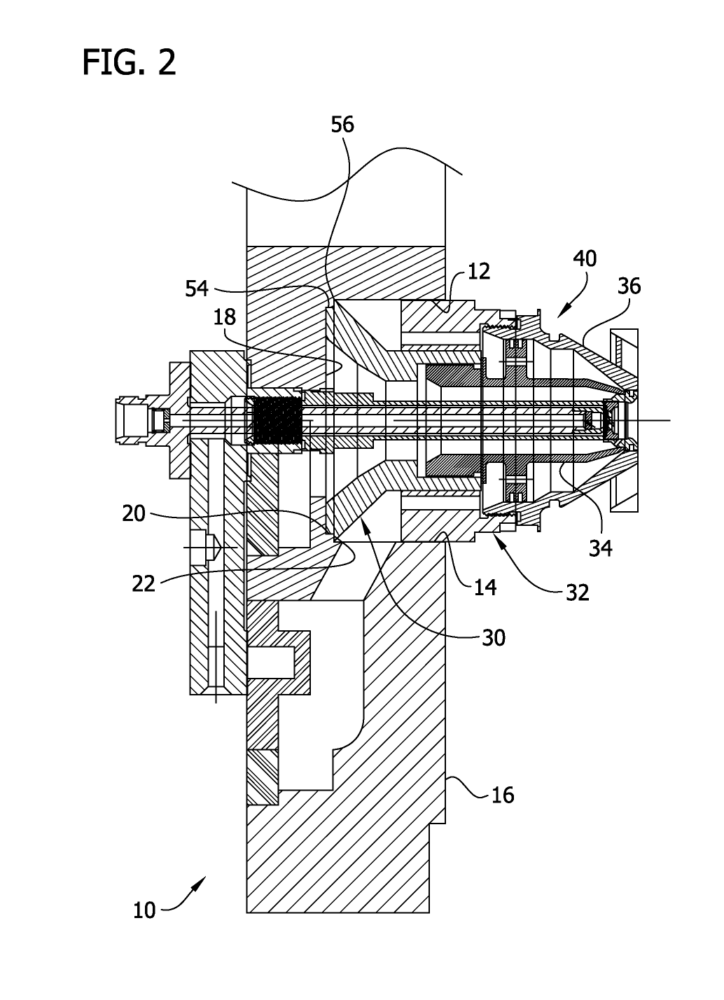

Referring to the drawings and in particular to FIG. 2, a retrofitted end cover or end plate for a combustor of a gas turbine engine is designated in its entirety by the reference number 10. Prior to retrofitting the end cover 10, existing inserts, such as that shown in FIG. 1, are removed and each end cover opening, generally designated by 12, is machined to a configuration as shown. Although the end cover 10 may have other numbers of openings 12 without departing from the scope of the present invention, in one embodiment the end cover has six openings equally spaced about the end cover. Each opening 12 includes a broad cylindrical area 14 extending into the end cover 10 at a generally constant inner diameter from a downstream face 16 of the end cover to a flat bottom 18. A circular rabbet land 20 and an annular face 22 are provided adjacent the bottom 18 of the opening 12. As will be appreciated by those skilled in the art, the broad cylindrical area 14 and the flat bottom 18 of the opening 12 may have larger machining tolerances than the rabbet land 20 and annular face 22. Thus, only a small area in each opening 12 has tighter machining tolerances, substantially reducing manufacturing cost. As will be understood by those skilled in the art, the circular rabbet land 20 has a tightly controlled outer diameter.

As further illustrated in FIG. 2, a first insert, generally designated 30, and a second insert, generally designated 32, are positioned in the opening 12 during retrofit. A conventional fuel nozzle 34 and a conventional swirler cup 36 are mounted on the first and second inserts, 30, 32, respectively, to complete a retrofitted fuel nozzle assembly, generally designated by 40.

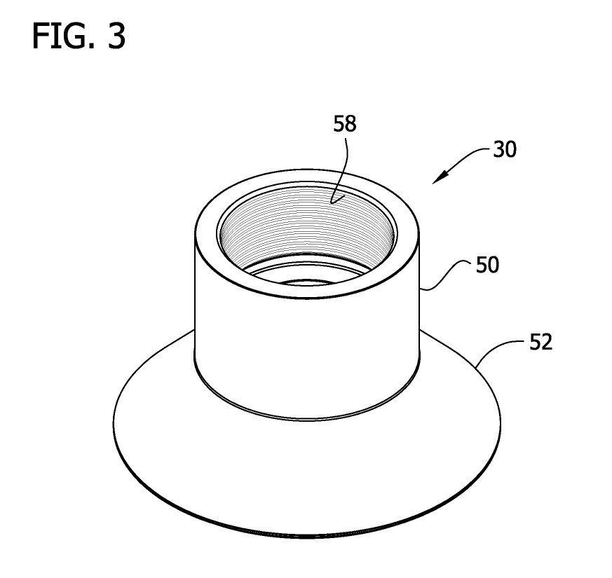

As illustrated in FIG. 3, the first insert 30 includes a cylindrical tip section 50 and a conically tapered base section 52. As shown in FIG. 2, the first insert 30 includes a circular rabbet land 54 sized for engaging the rabbet surface 20 in the opening 12 to center the first insert in the opening. The first insert 30 also includes an annular face 56 adapted to engage the annular face 22 near the bottom 18 of the opening 12 when the first insert is fully seated in the opening. As further illustrated in FIG. 3, the first insert 30 also includes a threaded portion 58 inside the cylindrical tip section 50 for fastening a conventional fuel nozzle 34 (FIG. 2) to the first insert.

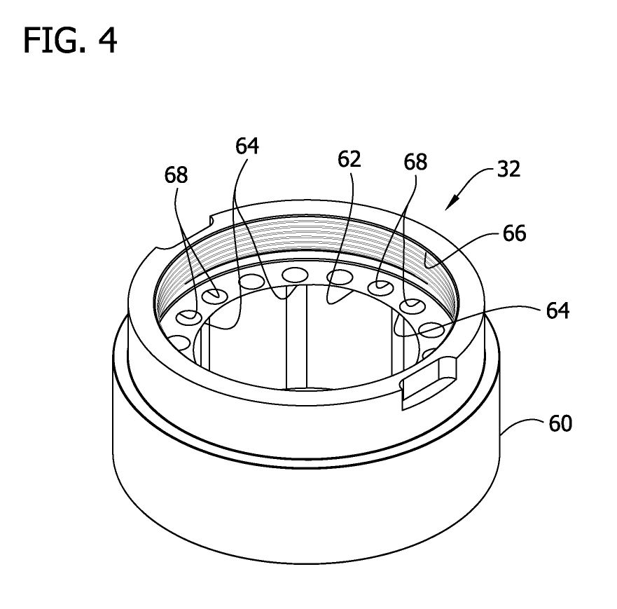

As illustrated in FIG. 4, the second insert 32 has a cylindrical outer diameter 60 sized for receipt inside the broad cylindrical area 14 of the end cover 10 opening 12. The second insert 32 includes a generally cylindrical central opening 62. Rather than being perfectly round, the central opening 62 has six equally spaced planar lands 64. The lands 64 engage the cylindrical portion 50 (FIG. 3) of the first insert 30 to center the second insert 32 relative to the first. Because the central opening 62 of the second insert 32 is not completely round, the second insert 32 only contacts the first insert 30 along six lines of contact. The reduced contact area provided by the lines of contact permits the second insert 32 to be removed from the first insert 30 more easily during later repair. Further, forming the retrofit insert in two pieces allows for different thermal expansion characteristics of the insert and end cover. The second insert 32 also includes a threaded central opening 66 downstream from the first insert 30 for receiving the conventional swirl cup 36 (FIG. 2). The second insert 32 includes passages 68 for delivering air and/or fuel to the swirl cup 36. As the design and configuration of these internal passages 68 are well known and well within the ordinary skill of those in the art, they will not be described in further detail.

Once the end cover 10 is prepared by removing existing inserts, if any, and machining the opening 12 as described above, the end cover may be retrofitted using a retrofit assembly comprising the first and second inserts, 30, 32, respectively, as described above. The first insert 30 is inserted into the opening 12 formed in the end cover 10 so the circular rabbet land 54 on the base section 52 engages the annual rabbet surface 20 in the opening 12 to center the first insert in the opening. The insert 30 is advanced into the opening 12 until the annular face 56 engages the annular face 22 near the bottom 18 of the opening. Once the first insert 30 is fully seated in the opening 12, the insert is joined to the end cover 10 to hold the base section 52 in position in the opening so the circular land engages the opening. Although the first insert 30 may be joined to the end cover 10 using other methods without departing from the scope of the present invention, in one embodiment the insert is welded to the end cover. In one particular embodiment, the insert 30 is welded to the end cover 10 entirely around the bottom of the base section 52 using a TIG weld process. As will be appreciated by those skilled in the art, other types of weld processes, such as MIG, EB, and laser, may also be used without departing from the scope of the present invention. The first insert 30 may be chilled, such as with dry ice, and/or the end cover 10 may be heated prior to inserting the insert in the opening to reduce potential interference preventing the insert from seating.

After the first insert 30 is joined to the end cover 10, the second insert 32 is inserted into the opening 12 so an outer diameter 60 of the second insert is positioned inside the opening. As described above the second insert 32 has six equally spaced planar lands 64 that engage the cylindrical portion 50 of the first insert 30 to center the second insert relative to the first. The second insert 32 may be heated to reduce potential interference preventing the insert from sliding over the tip portion 50 of the first insert 30. Tooling (not shown) may be screwed into the threaded central opening 66 of the second insert 32 to establish how far the second insert can be inserted into the opening 12. Once the second insert 32 is properly positioned, the insert is joined to the end cover 10 to hold it in position in the opening 12. Although the second insert 32 may be joined to the end cover 10 using other methods without departing from the scope of the present invention, in one embodiment the insert is welded to the end cover. In one particular embodiment, the second insert 32 is welded to the end cover 10 entirely around its outer diameter 60. In one embodiment, a TIG weld process is used but those skilled in the art will appreciate other welding processes may be used without departing from the scope of the present invention. After the second insert 32 is welded in position, the tooling may be removed from the central opening 66 in the insert.

The fuel nozzle assembly may be completed by threading a conventional fuel nozzle 34 into the threads 58 in the insert 30, and inserting a conventional swirl cup 36 cover the fuel nozzle before threading the cup into the threaded central opening 66 of the second insert 32.

Using weld processes to connect the inserts 30, 32 to the end cover 10 eliminates the need to heat treat the end cover as was required when brazing processes were used. Further, if the inserts need to be replaced, the inserts can be machined out without disturbing the tighter tolerance portions of the opening 12. Thus, more repairs may be performed on the end cover before a new end cover is needed.

Having described the invention in detail, it will be apparent that modifications and variations are possible without departing from the scope of the invention defined in the appended claims.

When introducing elements of the present invention or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A method for retrofitting an end cover of a combustor of a gas turbine engine comprising:
inserting a first insert into an opening formed in an end cover of a combustor of a gas turbine engine so a circular land on a base of said first insert centers the first insert in the opening and so an annular face on said first insert engages a face of the opening, said first insert including a cylindrical tip section opposite the base having a predetermined outer diameter sized smaller than a diameter of the opening;
joining the base of said first insert to the opening when the base engages the face of the opening to hold the base in position in the opening so the circular land engages the opening;
inserting a second insert into the opening formed in the end cover so an outer diameter of the second insert is positioned inside the diameter of the opening, said second insert having an inner land adapted to engage the outer diameter of the first insert to position the second insert relative to said first insert and the opening in the end cover; and
joining said second insert to the end cover.

2. A method as set forth in claim 1 wherein joining the base of the first insert to the opening in the end cover comprises welding the base of the first insert to the end cover.

3. A method as set forth in claim 2 wherein welding the base of the first insert to the end cover includes welding entirely around the base.

4. A method as set forth in claim 1 wherein joining said second insert to the end cover comprises welding the second insert to the end cover.

5. A method as set forth in claim 4 wherein welding the second insert to the end cover includes welding entirely around the second insert.

6. A method as set forth in claim 1 further comprising attaching a fixture to the second insert prior to inserting the second insert into the opening in the end cover, said fixture being adapted to determine a depth to which the second insert is inserted into the opening in the end cover.

7. A method as set forth in claim 1 further comprising:
inserting a fuel nozzle into a central opening in the first insert; and
connecting the fuel nozzle to the first insert.

8. A method as set forth in claim 7 wherein connecting the fuel nozzle to the first insert comprises threading the nozzle into threads in the central opening in the first insert.

9. A method as set forth in claim 7 further comprising:
inserting a swirl cup over the fuel nozzle; and
connecting the swirl cup to the second insert.

10. A method as set forth in claim 9 wherein connecting the swirl cup to the second insert comprises threading the swirl cup into threads in a central opening in the second insert.

11. An assembly for retrofitting an end cover of a combustor of a gas turbine engine, the end cover having a opening therein, the assembly comprising:
a first insert having a circular land sized for centering the first insert in the opening, an annular face adapted to engage a face of the opening when the first insert in inserted in the opening, a cylindrical tip section opposite the base having a predetermined outer diameter sized smaller than a diameter of the opening, and a central opening sized for receiving a fuel nozzle therein; and
a second insert having an outer diameter sized for receipt inside the diameter of the opening, an inner land adapted to engage the outer diameter of the first insert to center the second insert relative to said first insert, and a central opening sized for receiving a swirl cup.

12. An assembly as set forth in claim 11 wherein the first insert includes a tapered section extending between the circular land and the cylindrical tip.

13. An assembly as set forth in claim 12 wherein the tapered section extending between the circular land and the cylindrical tip is conical.

14. An assembly as set forth in claim 11 wherein the central opening of the first insert includes a threaded section adapted for engaging the fuel nozzle.

15. An assembly as set forth in claim 11 wherein the central opening of the second insert includes a threaded section adapted for engaging the swirl cup.

16. An assembly as set forth in claim 11 wherein the central opening of the second insert comprises a generally circular wall interrupted by a plurality of lobes sized to engage the outer diameter of the first insert to center the second insert relative to said first insert.

17. An assembly as set forth in claim 16 wherein each of the plurality of lobes is generally planer.

18. An assembly as set forth in claim 16 wherein the plurality of lobes consists of six lobes.

19. An end cover assembly of a combustor of a gas turbine engine, the end cover assembly comprising:
a plate including a combustion chamber face adapted for facing when in use a combustion chamber and an exterior face opposite said combustion chamber face, said combustion chamber face having a plurality of openings therein, each of said plurality of openings including an annular face face, a circular rabbet land, a diameter, and an opening extending from the opening to the exterior face of the plate;
a plurality of first inserts, each of said plurality of first inserts being positioned in one of said plurality of openings in the plate and having a circular land engaging the circular rabbet land of the corresponding opening for centering the first insert in the opening, an annular face engaging the annular face of the corresponding opening, a cylindrical tip section opposite the base having an outer diameter smaller than the diameter of the opening, and a central opening; and
a plurality of second inserts, each of said plurality of second inserts having an outer diameter sized for receipt inside the corresponding opening, a generally circular inner wall interrupted by a plurality of lobes engaging the outer diameter of the first insert to center the second insert relative to said first insert, and a central opening.

20. An assembly as set forth in claim 19 further comprising:
a plurality of fuel nozzles, each of said fuel nozzles being positioned in the central opening of one of said plurality of first inserts; and
a plurality of swirler cups, each of said swirler cups being positioned in the central opening of one of said plurality of second inserts.

21. An assembly as set forth in claim 19 wherein:
said plurality of openings in the plate consist of six openings;
said plurality of first inserts consists of six first inserts; and
said plurality of second inserts consists of six second inserts.
